(19) United States
(12) Patent Application Publication
(10) Pub. No.: US 2016/0285104 A1
(43) Pub. Date: Sep. 29, 2016

(54) Si-BLOCK COPOLYMER CORE-SHELL NANOPARTICLES TO BUFFER VOLUMETRIC CHANGE AND ANODE ACTIVE MATERIAL FOR LITHIUM SECONDARY BATTERY USING THE SAME

(71) Applicant: OCI COMPANY LTD., Seoul (KR)

(72) Inventors: Yo-Seop KIM, Seongnam-si (KR); Eun-Hye JEONG, Seongnam-si (KR); Sung-Ho JUNG, Seongnam-si (KR); Hyung-Rak KIM, Seongnam-si (KR)

(21) Appl. No.: 15/083,094

(22) Filed: Mar. 28, 2016

Related U.S. Application Data
(62) Division of application No. 14/263,656, filed on Apr. 28, 2014.

(30) Foreign Application Priority Data
May 14, 2013 (KR) 10-2013-0054163

(51) Int. Cl. H01M 4/62; C08J 3/11; H01M 4/04; H01M 4/134; H01M 4/1395

(52) U.S. Cl. CPC H01M 4/628; H01M 4/134; H01M 4/1395; H01M 4/0402; H01M 4/0471; C08J 3/11; C08J 2353/00

(57) ABSTRACT

The Si-block copolymer core-shell nanoparticles include: a Si core; and a block copolymer shell including a block having relatively relatively high affinity for Si and a block having relatively low affinity for Si and forming a spherical micelle structure around the Si core. Since the Si-block copolymer core-shell nanoparticles exhibit excellent dispersibility and stability in a mixed solution including the same, the Si-block copolymer core-shell nanoparticles are easily applied to an anode active material for lithium secondary battery by carbonization thereof. In addition, since the anode active material for lithium secondary battery using the Si-block copolymer core-shell nanoparticles includes carbonized Si-block copolymer core-shell nanoparticles and pores, the anode active material has long lifespan, high capacity and high energy density, and the block copolymer shell of the carbonized Si-block copolymer core-shell nanoparticles can improve lifespan of lithium secondary battery by buffering volumetric change thereof during charge and discharge.

### CROSS-REFERENCE TO RELATED APPLICATIONS

This present application is a Divisional Application of U.S. Ser. No. 14/263,656 filed Apr. 28, 2014, which claims the benefit from Korean Patent Application No. 10-2013-0054163, filed on May 14, 2013 in the KIPO (Korean Intellectual Property Office), the disclosure of which are incorporated herein in their entirety by reference.

### BACKGROUND

1. Technical Field

The present invention relates to Si-block copolymer core-shell nanoparticles to buffer volumetric change and anode active material for lithium secondary battery using the same.

2. Description of the Related Art

With the development of technology and increasing demand for mobile devices, demand for secondary batteries as an energy source is rapidly increasing, and lithium secondary batteries, which exhibit high energy density and operating potential and a low self-discharge rate, and has a long cycle life, are commercialized and widely used in the art.

Moreover, as interest in environmental problems increases, electric vehicles and hybrid electric vehicles, which can replace vehicles using fossil fuels, such as gasoline vehicles, diesel vehicles, and so on, are a focus of study, and lithium secondary batteries are in a commercialization stage as a power source for such electric vehicles, hybrid electric vehicles, and the like.

Although lithium has been used as an anode active material in the art, there is a danger of explosion upon short circuit of the battery due to formation of dendrites when lithium is used. Thus, a carbon-based material is widely used as the anode active material instead of lithium.

Examples of the carbon-based material used as an anode active material for lithium secondary batteries include crystalline carbon such as natural graphite and artificial graphite, and amorphous carbon such as soft carbon and hard carbon. However, the amorphous carbon has a problem of high irreversibility during charge and discharge despite large capacity. Among the crystalline carbon, graphite is typically used as an anode active material. Although graphite has a high theoretical limit capacity of 372 mAh/g as the anode active material, graphite suffers from severe deterioration in lifespan.

Moreover, since graphite or carbon-based active materials have a capacity of about 372 mAh/g at most despite large theoretical capacity thereof, there is a problem in that the aforementioned anode cannot be applied to high-capacity lithium secondary batteries.

To solve such problems, metal or intermetallic compound-based anode active materials have been actively studied in recent years. For example, lithium secondary batteries using metal or semimetal, such as aluminum, germanium, silicon, tin, zinc, lead, and the like, as the anode active material have been studied in the art. Since such materials have high capacity and high energy density, and can occlude and release more lithium ions than anode active materials using the carbon-based material, it is believed that a lithium secondary battery having high capacity and high energy density can be prepared using such materials. For example, pure silicon is known to have a high theoretical capacity of 4017 mAh/g.

However, silicon anodes have difficulties in commercialization due to deterioration of cycle properties as compared with the carbon-based materials, since conductivity between active materials deteriorates due to volume change during charge and discharge, or the anode active material is peeled from an anode current collector, when inorganic particles, such as silicon and tin, are used as the anode active material to occlude and release lithium. That is, since the inorganic particles, such as silicon and tin, included in the anode active material occlude lithium during charge, the volume of the inorganic particles expands by about 300% to 400%. In addition, the inorganic particles contract when lithium is released during discharge. Since the lithium secondary battery can suffer from rapid deterioration in lifespan due to possible electrical insulation caused by an empty space generated between the inorganic particles and the anode active material during repeated charge and discharge, the inorganic particles have a serious obstacle to application to lithium secondary batteries.

### BRIEF SUMMARY

The present invention is aimed at forming a layer to buffer volumetric change due to Si during charge and discharge of a lithium secondary battery during dispersion and coating processes. It is an aspect of the present invention to provide Si-block copolymer core-shell nanoparticles, which include: a Si core; and a block copolymer shell including a block having relatively high affinityrelatively relatively high affinity for Si and a block having relatively low affinity for Si and forming a spherical micelle structure around the Si core, and an anode active material including the same.

However, aspects of the present invention are not limited to the above aspects, and other aspects of the present invention will become apparent to those skilled in the art from the following description.

In accordance with one aspect of the present invention, Si-block copolymer core-shell nanoparticles include: a Si core; and a block copolymer shell including a block having relatively high affinityrelatively relatively high affinity for Si and a block having relatively low affinity for Si and forming a spherical micelle structure around the Si core.

One embodiment of the present invention provides a method of preparing a mixed solution including Si-block copolymer core-shell nanoparticles, which includes: a) mixing a block copolymer including a block having relatively high affinityrelatively relatively high affinity for Si and a block having relatively low affinity for Si with a solvent; b) adding Si particles into the mixed solution; and c) dispersing and coating the mixed solution containing the Si particles.

Another embodiment of the present invention provides carbonized Si-block copolymer core-shell nanoparticles formed by carbonization of the Si-block copolymer core-shell nanoparticles.

A further embodiment of the present invention provides an anode active material for lithium secondary battery, which includes: amorphous carbon including pores therein; and the carbonized Si-block copolymer core-shell nanoparticles dispersed in the pores.

The present invention relates to Si-block copolymer core-shell nanoparticles, which include: a Si core; and a block copolymer shell including a block having relatively high affinity for Si and a block having relatively low affinity for Si and forming a spherical micelle structure around the Si core. Since the Si-block copolymer core-shell nanoparticles exhibit excellent dispersibility and stability in a mixed solution including the same, the Si-block copolymer core-shell nanoparticles can be easily applied to anode active materials for lithium secondary battery through carbonization thereof. In addition, since an anode active material for lithium secondary battery using the Si-block copolymer core-shell nanoparticles includes the carbonized Si-block copolymer core-shell nanoparticles and the pores, the anode active material has long lifespan, high capacity and high energy density, and the block copolymer shell of the carbonized Si-block copolymer core-shell nanoparticles can improve lifespan of lithium secondary battery by buffering volumeric change thereof during charge and discharge.

### BRIEF DESCRIPTION OF THE DRAWINGS

The above and other aspects, features, and advantages of the present invention will become apparent from the detailed description of the following embodiments in conjunction with the accompanying drawings, in which:

FIG. 1 shows a total diameter of Si-block copolymer core-shell nanoparticles depending upon a weight ratio of a Si core to a block copolymer shell, as measured by dynamic light scattering;

FIG. 2A shows Si-block copolymer core-shell nanoparticles as observed by energy dispersive X-ray spectroscopy;

FIG. 2B shows Si nanoparticles, as observed by energy dispersive X-ray spectroscopy;

FIG. 3A shows Si-block copolymer core-shell nanoparticles as observed by scanning electron microscopy;

FIG. 3B shows Si nanoparticles, as observed by scanning electron microscopy;

FIG. 4A shows Si-block copolymer core-shell nanoparticles as observed by transmission electron microscopy;

FIG. 4B shows Si nanoparticles, as observed by transmission electron microscopy;

FIG. 5 shows dispersibility of (a) Si-block copolymer core-shell nanoparticles in a mixed solution including the same and that of (b) Si nanoparticles in a mixed solution including the same, as confirmed by dynamic light scattering;

FIG. 6A shows results observed visually of Si-block copolymer core-shell nanoparticles in a mixed solution including the same according to concentration of Si cores;

FIG. 6B shows results observed visually of Si nanoparticles in a mixed solution including the same according to concentration of the Si nanoparticles;

FIG. 6C shows dispersion heights of Si-block copolymer core-shell nanoparticles in a mixed solution including the same according to concentration of Si cores and Si nanoparticles in a mixed solution including the same according to concentration of the Si nanoparticles;

FIG. 7 shows results observed visually and particle size distribution of each of Si-block copolymer core-shell nanoparticles in a mixed solution including the same (“P4”˜“P9”), Si nanoparticles in a mixed solution including the same (“C”), and a Si-polystyrene mixture in a mixed solution including the same (“STY”);

FIG. 8A shows each result of Si-block copolymer core-shell nanoparticles as observed by scanning electron microscopy and transmission electron microscopy, and analyzed by energy dispersive X-ray spectroscopy;

FIG. 8B shows each result of carbonized Si-block copolymer core-shell nanoparticles, as observed by scanning electron microscopy and transmission electron microscopy, and analyzed by energy dispersive X-ray spectroscopy;

FIG. 9A shows carbonized Si-block copolymer core-shell nanoparticles as observed by transmission electron microscopy; and

FIG. 9B shows carbonized Si-polyphenol particles as observed by transmission electron microscopy.

### DETAILED DESCRIPTION

The present invention provides Si-block copolymer core-shell nanoparticles, which include: a Si core; and a block copolymer shell including a block having relatively high affinity for Si and a block having relatively low affinity for Si and forming a spherical micelle structure around the Si core.

The core-shell nanoparticles have a structure in which the block copolymer shell including a block having relatively high affinity for Si and a block having relatively low affinity for Si is coated onto a surface of the Si core, and the block copolymer shell of the core-shell nanoparticles forms a spherical micelle structure, in which the blocks having relatively high affinity for Si are drawn toward the surface of the Si core and the blocks having relatively low affinity for Si are drawn toward the outside of the Si core by van der Waals interaction and the like.

In this way, the block copolymer shell of the core-shell nanoparticles forms a spherical micelle structure around the Si core, and, since the core-shell nanoparticles exhibit excellent dispersibility and stability in a mixed solution including the core-shell nanoparticles, the core-shell nanoparticles reduce agglomeration of particles, and thus have a smaller particle size than simple nanoparticles.

The core-shell nanoparticles preferably have a weight ratio of the Si core to the block copolymer shell in the range of 2:1 to 1000:1, more preferably 4:1 to 20:1, without being limited thereto. Here, if the weight ratio of the Si core to the block copolymer shell is less than 2:1, the amount of the Si core capable of being actually alloyed with lithium is decreased in an anode active material, thereby causing deterioration in capacity of the anode active material and efficiency of lithium secondary battery. Conversely, if the weight ratio of the Si core to the block copolymer shell is greater than 1000:1, the amount of the block copolymer shell is decreased, and dispersibility and stability deteriorate in the mixed solution including the core-shell nanoparticles, thereby causing a problem in that the block copolymer shell of the carbonized core-shell nanoparticles cannot properly perform buffering action.

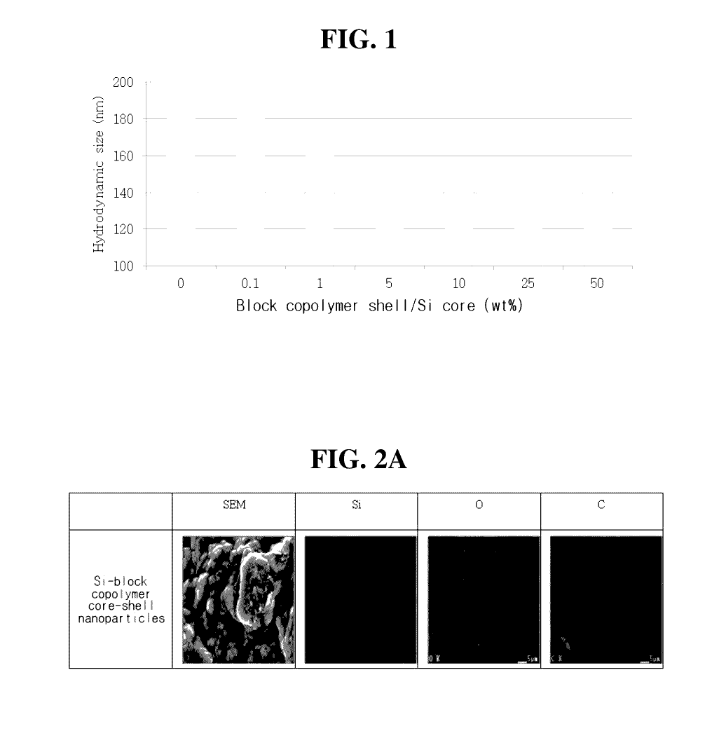

FIG. 1 shows a total diameter of Si-block copolymer core-shell nanoparticles depending upon a weight ratio of a Si core to a block copolymer shell, as measured by dynamic light scattering.

As shown in FIG. 1, it can be seen that, when the weight ratio of the Si core to the block copolymer shell ranges from 2:1 (the block copolymer shell/Si core is present in an amount of 50% by weight (wt %)) to 1000:1 (the block copolymer shell/Si core is present in an amount of 0.1 wt %) in the Si-block copolymer core-shell nanoparticles, particularly, when the weight ratio of the Si core to the block copolymer shell ranges from 4:1 (the block copolymer shell/Si core is present in an amount of 25 wt %) to 20:1 (the block copolymer shell/Si core is present in an amount of 5 wt %) in the Si-block copolymer core-shell nanoparticles, the Si-block copolymer core-shell nanoparticles have a greatly reduced total diameter (hydrodynamic size), as compared with Si nanoparticles (the block copolymer shell/Si core is present in an amount of 0 wt %), and thus exhibit excellent dispersibility and stability.

That is, the block copolymer shell of the carbonized core-shell nanoparticles is a material for buffering volumetric change due to Si during charge and discharge of the lithium secondary battery instead of being alloyed with lithium in an anode active material, and may be included in a small quantity as compared with the Si core.

In addition, the Si core may be a sphere shape having a diameter from 2 nm to 200 nm, and the block copolymer shell may have a thickness from 1 nm to 50 nm

A ratio of diameter of the Si core to thickness of the block copolymer shell may range from 1:25 to 200:1, without being limited thereto. When the ratio of diameter of the Si core to thickness of the block copolymer shell is maintained at 1:25 to 200:1, the Si-block copolymer core-shell nanoparticles are particularly suitable for application to a Si/amorphous carbon/crystalline carbon composite having a cabbage structure aimed at dimensional stability of an electrode in response to volume expansion of Si.

Thus, the Si-block copolymer core-shell nanoparticles have a structure in which the block copolymer shell is coated onto the surface of the Si core around the Si core, and may have a total diameter from 4 nm to 300 nm.

The blocks having relatively high affinity for Si are drawn toward the surface of the Si core by van der Waals interaction and the like. Here, the block having relatively high affinity for Si may include polyacrylic acid, polyacrylate, polymethacrylic acid, polymethyl methacrylate, polyacryl amide, carboxymethyl cellulose, polyvinyl acetate, or polymaleic acid, without being limited thereto.

The blocks having relatively low affinity for Si are drawn toward the outside of the Si core by van der Waals interaction and the like. Here, the blocks having relatively low affinity for Si may include polystyrene, polyacrylonitrile, polyphenol, polyethylene glycol, polylauryl methacrylate, or polyvinyl difluoride, without being limited thereto.

The block copolymer shell may be a polyacrylic acid-polystyrene block copolymer shell. Here, the polyacrylic acid may have a number average molecular weight (Mₙ) from 100 g/mol to 100,000 g/mol, and the polystyrene may have a number average molecular weight (Mₙ) from 100 g/mol to 100,000 g/mol, without being limited thereto.

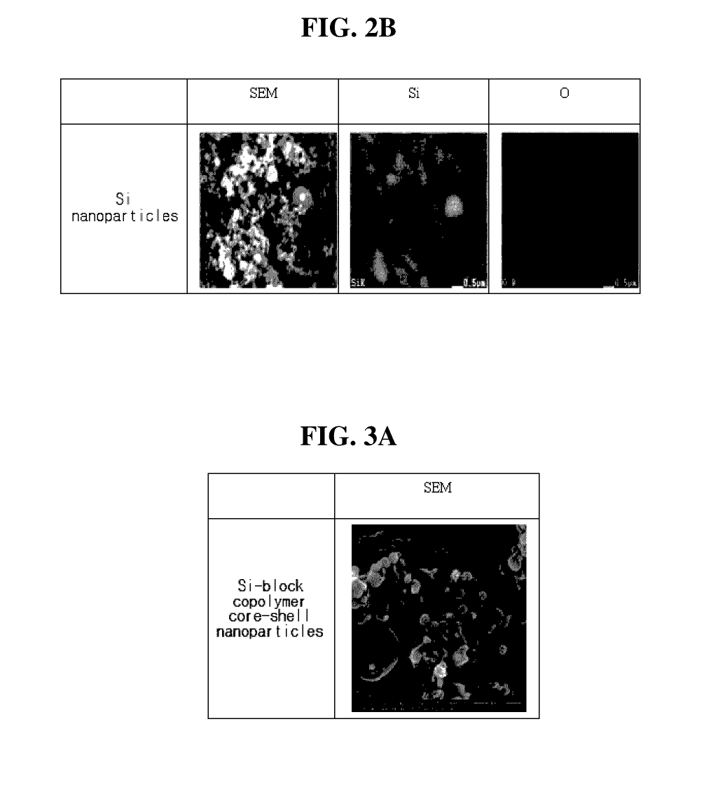

FIG. 2A shows Si-block copolymer core-shell nanoparticles and FIG. 2B shows Si nanoparticles, as observed by energy dispersive X-ray spectroscopy.

In FIG. 2A and FIG. 2B, from distribution of Si, C, and O, it can be seen that the Si-block copolymer core-shell nanoparticles have a C and O-containing polymer shell formed on the surface of the Si core unlike the Si nanoparticles.

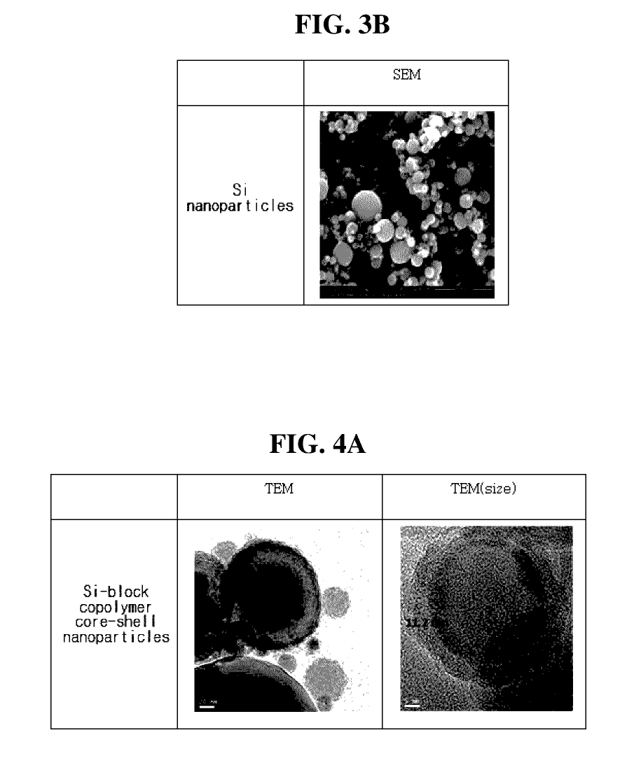

FIG. 3A shows Si-block copolymer core-shell nanoparticles and FIG. 3B shows Si nanoparticles, as observed by scanning electron microscopy.

In FIG. 3A and FIG. 3B, it can be seen that the Si-block copolymer core-shell nanoparticles have a polymer shell formed on the surface of the Si core unlike the Si nanoparticles.

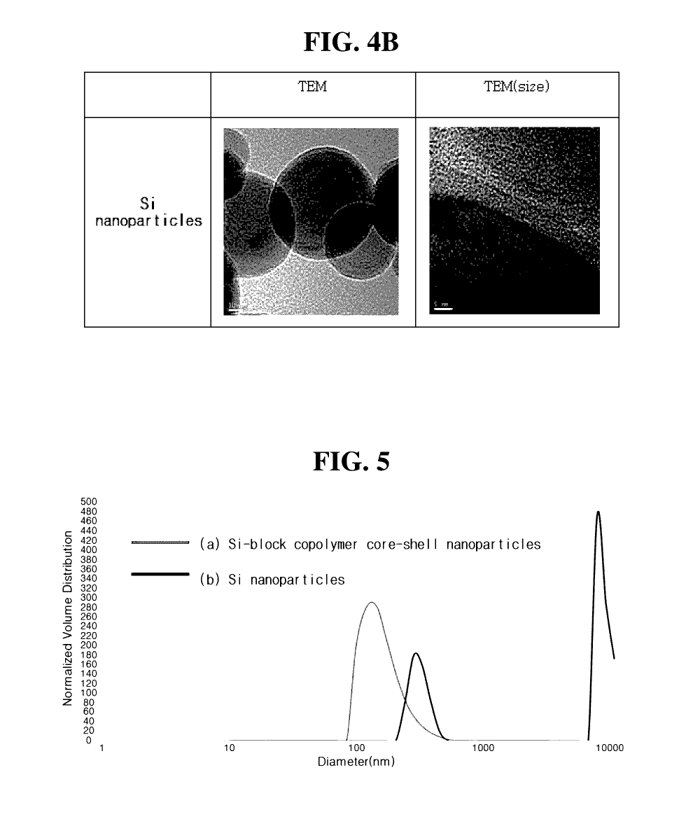

FIG. 4A shows Si-block copolymer core-shell nanoparticles and FIG. 4B shows Si nanoparticles, as observed by transmission electron microscopy.

In FIG. 4A and FIG. 4B, it can be seen that the Si-block copolymer core-shell nanoparticles have a polymer shell formed on the surface of the Si core unlike the Si nanoparticles, and that the polymer shell formed on the surface of the Si core has a thickness of 11.2 nm.

In addition, the present invention provides a method of preparing a mixed solution including Si-block copolymer core-shell nanoparticles, which includes: a) mixing a block copolymer including a block having relatively high affinity for Si and a block having relatively low affinity for Si with a solvent; b) adding Si particles into the mixed solution; and c) dispersing and coating the mixed solution containing the Si particles.

Dispersion and coating of Si particles may be performed at room temperature (15° C. to 25° C.).

Generally, for coating of nanoparticles, separate reaction, such as heat treatment, high-pressure treatment, purging of oxygen and air, and the like, is essential. The method according to the invention has a merit in that dispersion and coating of the Si particles can be performed at room temperature at the same time without separate reaction, such as heat treatment, high-pressure treatment, purging of oxygen and air, and the like.

In operation a), a block copolymer including a block having relatively high affinity for Si and a block having relatively low affinity for Si are mixed with a solvent.

In operation a), the solvent may be at least one selected from the group consisting of N-methyl-2-pyrrolidone (NMP), tetrahydrofuran (THF), water, methanol, ethanol, cyclohexanol, cyclohexanone, methyl ethyl ketone, acetone, dimethyl sulfoxide (DMSO), and mixtures thereof, without being limited thereto. Here, when N-methyl-2-pyrrolidone (NMP) or tetrahydrofuran (THF) is used as the solvent, the core-shell nanoparticles exhibit excellent dispersibility and stability without phase separation in the mixed solution including the core-shell nanoparticles according to the invention.

In operation a), the block having relatively high affinity for Si may include polyacrylic acid, polyacrylate, polymethacrylic acid, polymethyl methacrylate, polyacryl amide, carboxymethyl cellulose, polyvinyl acetate, or polymaleic acid, without being limited thereto.

In operation a), the block having relatively low affinity for Si may include polystyrene, polyacrylonitrile, polyphenol, polyethylene glycol, polylauryl methacrylate, or polyvinyl difluoride, without being limited thereto.

In operation a), the block copolymer may be a polyacrylic acid-polystyrene block copolymer. Here, the polyacrylic acid may have a number average molecular weight (Mₙ) from 100 g/mol to 100,000 g/mol, and the polystyrene may have a number average molecular weight (Mₙ) from 100 g/mol to 100,000 g/mol, without being limited thereto.

In operation a), the block copolymer may be prepared by any of various livingpolymerization methods. In this invention, the block copolymer is prepared by reversible addition fragmentation chain transfer of the block having relatively high affinity for Si and the block having relatively low affinity for Si.

In operation b), Si particles are added into the mixed solution.

In operation b), the Si particles are preferably added in a weight ratio of the Si particles to the block copolymer in the range of 2:1 to 1000:1, more preferably 4:1 to 20:1, without being limited thereto.

That is, the block copolymer shell is a material for providing a buffering function instead of being alloyed with lithium in an anode active material, and may be added in a small quantity as compared with the Si particles.

In operation c), the mixed solution containing the Si particles is dispersed and coated.

Dispersion and coating may be performed by various treatment methods such as ultrasonication, fine milling, ball milling, three roll milling, stamp milling, eddy milling, homo mixing, planetary centrifugal mixing, homogenization or vibration shaker treatment, and the like. Here, ultrasonic treatment may be performed for 1 minute to 120 minutes using ultrasonication at 10 kHz to 100 kHz, without being limited thereto.

The mixed solution containing the Si particles is subjected to Ultrasonic treatment, thereby preparing a mixed solution in which the core-shell nanoparticles are dispersed instead of a simple mixed solution of Si particles and block copolymers. Here, ultrasonic treatment is performed for 5 minutes to 120 minutes at 10 kHz to 100 kHz, thereby minimizing energy loss through short duration ultrasonication.

The block copolymer of the core-shell nanoparticles forms a spherical micelle structure around the Si core in the mixed solution including the core-shell nanoparticles. Since the core-shell nanoparticles in the mixed solution including the core-shell nanoparticles exhibit excellent dispersibility and stability and exhibit reduced agglomeration and thus have a smaller particle size, as compared with Si particles in a mixed solution containing the Si particles or a Si-polystyrene mixture in a mixed solution containing the Si-polystyrene mixture.

Here, the Si-block copolymer core-shell nanoparticles preferably have a particle size distribution from 4 nm to 300 nm, more preferably from 100 nm to 150 nm, without being limited thereto.

In addition, the Si core may have a wide concentration range of 1 wt % to 50 wt % in the mixed solution including the core-shell nanoparticles.

Thus, with excellent dispersibility and stability in the mixed solution, the core-shell nanoparticles can be easily applied to an anode active material through carbonization.

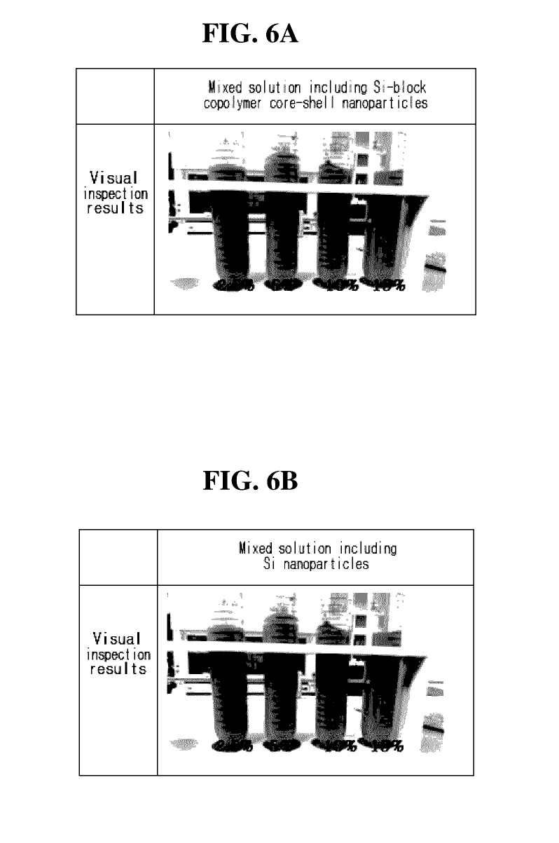

FIG. 5 shows dispersibility of (a) Si-block copolymer core-shell nanoparticles in a mixed solution including the core-shell nanoparticles and that of (b) Si nanoparticles in a mixed solution including the same, as confirmed by dynamic light scattering.

As shown in FIG. 5, when tetrahydrofuran (THF) is used as the solvent, it can be seen that the (a) Si-block copolymer core-shell nanoparticles have a significantly smaller particle size in the mixed solution including the same than the (b) Si nanoparticles in the mixed solution including the Si nanoparticles.

This is because the block copolymer shell of the core-shell nanoparticles forms a spherical micelle structure around the Si core and the core-shell nanoparticles in the mixed solution including the core-shell nanoparticles exhibit excellent dispersibility and stabilityand exhibit reduced agglomeration and thus have a smaller particle size , as compared with Si particles in a mixed solution containing the Si particles.

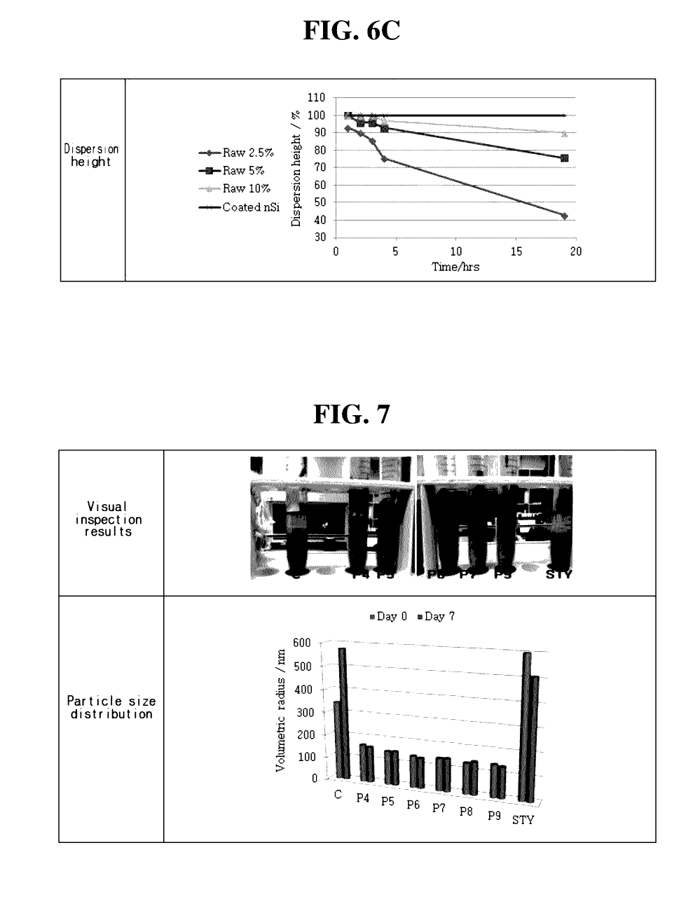

FIG. 6A shows results observed visually of Si-block copolymer core-shell nanoparticles in a mixed solution including the same according to concentration of Si cores and FIG. 6B shows results observed visually of Si nanoparticles in a mixed solution including the same according to concentration of the Si nanoparticles

And FIG. 6C shows dispersion heights of Si-block copolymer core-shell nanoparticles in a mixed solution including the same according to concentration of Si cores and Si nanoparticles in a mixed solution including the same according to concentration of the Si nanoparticles

As shown in FIG. 6A to FIG. 6C when tetrahydrofuran (THF) is used as the solvent, it can be seen that, although the dispersion heights increase with increasing concentration of the Si nanoparticles when the Si nanoparticles have a concentration of 2.5 wt %, 5 wt %, and 10 wt % in the mixed solution including the same, the dispersion heights of the Si nanoparticles are much lower than those of the Si-block copolymer core-shell nanoparticles when the Si cores have a concentration of 2.5 wt %, 5 wt %, and 10 wt % in the mixed solution including the Si-block copolymer core-shell nanoparticles. In particular, when the Si nanoparticles have a concentration of 15 wt % in the mixed solution, the dispersion height of the Si nanoparticles cannot be measured since the nanoparticles are dried and adhere to the inside of a test tube. However, it can be seen that, even when the Si cores have a concentration of 15 wt % in the mixed solution including the Si-block copolymer core-shell nanoparticles, the Si-block copolymer core-shell nanoparticles maintain a high dispersion height without phase separation.

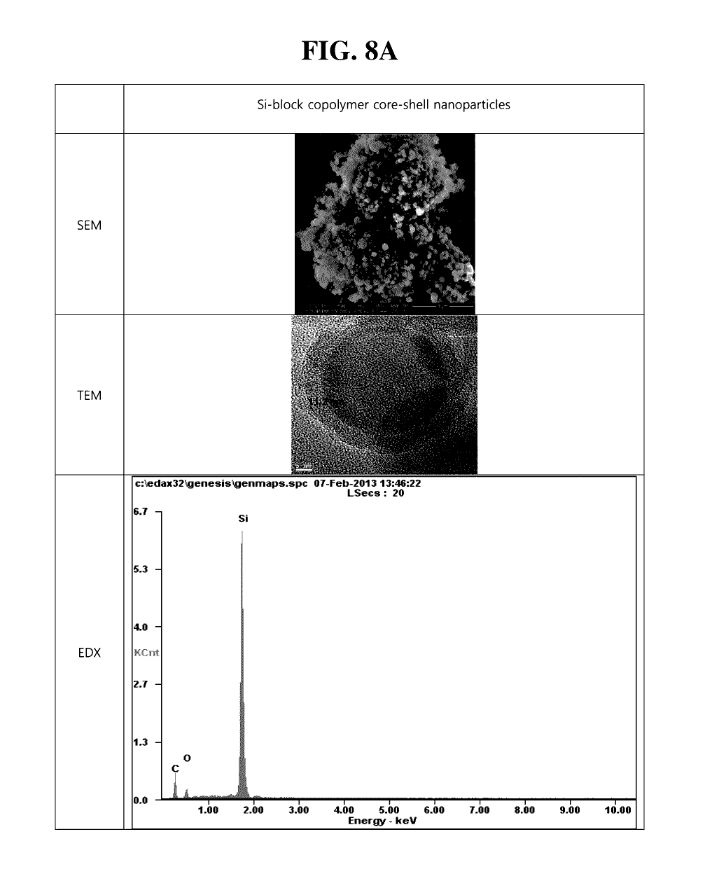

FIG. 7 shows results observed visually and particle size distribution of each of Si-block copolymer core-shell nanoparticles (“P4˜P9”) in a mixed solution including the same, Si nanoparticles (“C”) in a mixed solution including the same, and a Si-polystyrene mixture (“STY”) in a mixed solution including the same.

As shown in FIG. 7, when tetrahydrofuran (THF) is used as the solvent, based on a particle size distribution of the Si nanoparticles (“C”) of about 350 nm in the mixed solution including the Si nanoparticles, the particle size distribution of the Si-polystyrene mixture (“STY”) is increased in the mixed solution including the Si-polystyrene mixture, whereas the particle size distribution of the Si-block copolymer core-shell nanoparticles (“P4”˜“P9”) ranges from 135 nm to 150 nm in the mixed solution including the Si-block copolymer core-shell nanoparticles. Thus, it can be seen that the Si-block copolymer core-shell nanoparticles exhibit excellent dispersibility and stability without phase separation.

Further, the present invention provides carbonized Si-block copolymer core-shell nanoparticles formed by carbonization of Si-block copolymer core-shell nanoparticles.

Furthermore, the present invention provides an anode active material for lithium secondary battery, which includes: amorphous carbon including pores therein; and the carbonized Si-block copolymer core-shell nanoparticles dispersed in the pores.

The anode active material for lithium secondary battery includes a Si/amorphous carbon/crystalline carbon composite, and has a cabbage structure providing dimensional stability of an electrode for buffering volumetric expansion of Si. Thus, since the anode active material for lithium secondary battery includes the nanoparticles and the pores, the anode active material has long lifespan, high capacity and high energy density, and can improve lifespan of the lithium secondary battery by buffering volumetric change during charge and discharge.

The amorphous carbon may include soft carbon, hard carbon and the like, and the crystalline carbon may include natural graphite, artificial graphite and the like.

The block copolymer shell of the carbonized core-shell nanoparticles may form a carbonized spherical layer around the Si core.

In addition, the carbonized core-shell nanoparticles may have a shell thickness of 10% to 50% the thickness of the block copolymer shell of the Si-block copolymer core-shell nanoparticles before carbonization.

That is, although the block copolymer shell of the carbonized core-shell nanoparticles has a slightly reduced thickness due to carbonization of the core-shell nanoparticles, the block copolymer shell maintains a certain thickness and the carbonized core-shell nanoparticles include the block having relatively high affinity for Si. Thus, the block copolymer shell remains on the surface of the Si core even after carbonization, whereby the block copolymer shell of the carbonized core-shell nanoparticles still forms a carbonized spherical layer around the Si core.

Here, the block copolymer shell of the carbonized core-shell nanoparticles is a material for buffering volumetric change due to Si during charge and discharge of the lithium secondary battery instead of being alloyed with lithium in the anode active material.

Thus, when the carbonized core-shell nanoparticles having a large specific surface area is applied to an anode active material for lithium secondary battery, the anode active material has high capacity and high energy density, and the block copolymer shell of the carbonized core-shell nanoparticles can buffer volumetric change due to Si during charge and discharge of the lithium secondary battery.

In the anode active material, a weight ratio of C to Si preferably ranges from 2:1 to 1000:1, more preferably from 4:1 to 20:1, without being limited thereto. Here, if the weight ratio of C to Si is less than 2:1, the anode active material can suffer from severe volume expansion during charge and discharge due to an excess of Si, thereby causing deterioration in lifespan of lithium secondary battery, and if the weight ratio of C to Si is greater than 1000:1, the anode active material has reduced capacity due to an insufficient amount of Si, thereby causing deterioration in efficiency of lithium secondary battery.

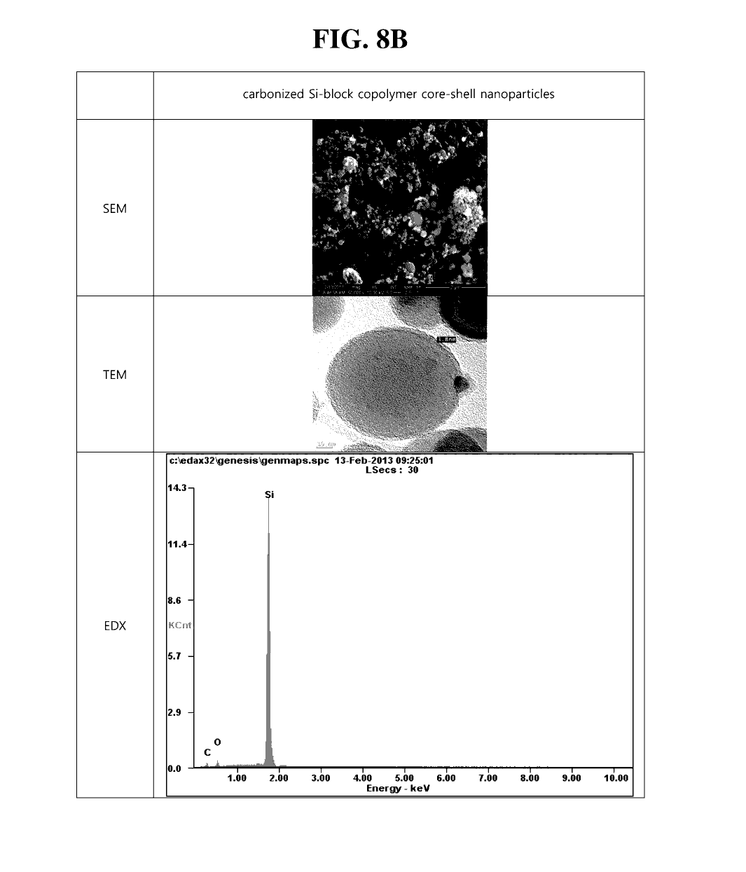

FIG. 8A shows each result of Si-block copolymer core-shell nanoparticles as observed by scanning electron microscopy and transmission electron microscopy, and analyzed by energy dispersive X-ray spectroscopy. And FIG. 8B shows each result of carbonized Si-block copolymer core-shell nanoparticles, as observed by scanning electron microscopy and transmission electron microscopy, and analyzed by energy dispersive X-ray spectroscopy.

In FIG. 8A and FIG. 8B, it can be seen that the carbonized Si-block copolymer core-shell nanoparticles also include the block copolymer shell remaining on the surface of the Si core like the Si-block copolymer core-shell nanoparticles. Here, it can be seen that the block copolymer shell of the carbonized Si-block copolymer core-shell nanoparticles has a thickness of 3.8 nm, which is about 34% a thickness of 11.2 nm of the block copolymer shell of the Si-block copolymer core-shell nanoparticles.

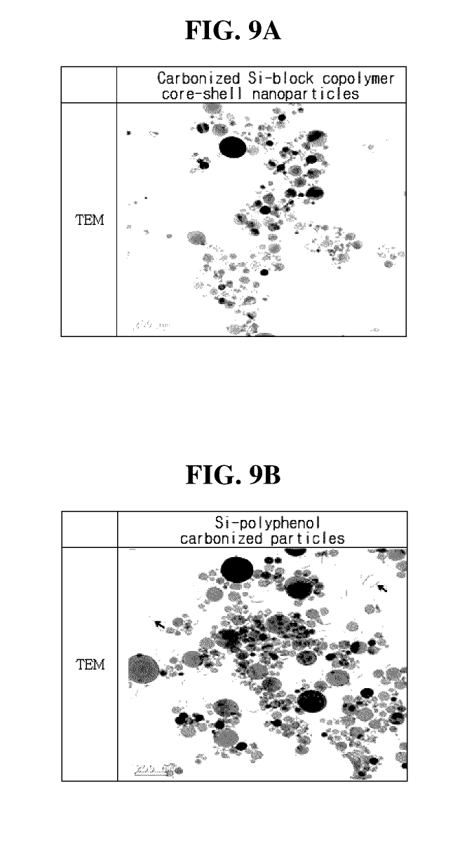

FIG. 9A shows carbonized Si-block copolymer core-shell nanoparticles and FIG. 9B shows carbonized Si-polyphenol particles as observed by transmission electron microscopy.

In FIG. 9A and FIG. 9B, it can be seen that, since the carbonized Si-polyphenol particles do not include the block having relatively high affinity for Si, the Si particles and the block copolymer are separated from each other after carbonization, whereas since the carbonized Si-block copolymer core-shell nanoparticles include the block having relatively high affinity for Si, the block copolymer shell remains on the surface of the Si core even after carbonization, and the block copolymer shell of the carbonized core-shell nanoparticles still forms a carbonized spherical layer around the Si core.

The present invention also provides an anode for lithium secondary battery, which includes: the anode active material for lithium secondary battery; a conductive material; and a binder. The anode for lithium secondary battery is prepared by coating the anode active material, the conductive material and the binder onto an anode current collector, followed by drying, and, optionally, may further include fillers.

Further, the present invention provides a lithium secondary battery, which includes: the anode for lithium secondary battery; a cathode including a cathode active material; and an electrolyte. The lithium secondary battery includes the cathode, the anode and a separator. Here, the separator insulates the electrodes between the cathode and the anode, may include a polyolefin separator typically known in the art, a composite separator in which an organic/inorganic composite layer is formed on an olefin substrate, and the like, without being limited thereto.

Furthermore, the present invention provides a middle or large-sized battery module or battery pack, which includes a plurality of lithium secondary batteries electrically connected to each other. The middle or large battery module or battery pack may be used as a middle or large device power supply of at least one of power tools; electric vehicles including electric vehicles (EVs), hybrid electric vehicles (HEVs), and plug-in hybrid electric vehicles (PHEVs); electric trucks; commercial electric vehicles; or power storage systems.

Hereinafter, the present invention will be described in more detail with reference to some examples. However, it should be noted that these examples are provided for illustration only and are not to be construed in any way as limiting the present invention.

### EXAMPLES

### Example 1

Preparation of Mixed Solution Including Core-Shell Nanoparticles

A polyacrylic acid-polystyrene block copolymer was prepared from polyacrylic acid and polystyrene through reversible addition fragmentation chain transfer. Here, the polyacrylic acid had a number average molecular weight (Mₙ) of 4090 g/mol, and the polystyrene had a number average molecular weight (Mₙ) of 29370 g/mol.

0.1 g of the polyacrylic acid-polystyrene block copolymer was mixed with 8.9 g of N-methyl-2-pyrrolidone (NMP) used as a solvent. 1 g of Si particles having a diameter of 50 nm was added to 9 g of the mixed solution.

The mixed solution to which the Si particles had been added was subjected to ultrasonication at 20 kHz for 10 minutes using a sonic horn, and then left for 20 minutes, thereby preparing a mixed solution including core-shell nanoparticles.

Preparation of Anode Active Material for Lithium Secondary Battery Using Core-Shell Nanoparticles

After evaporating N-methyl-2-pyrrolidone (NMP) from the mixed solution including the core-shell nanoparticles at 80° C. and 30 mbar in a vacuum oven, the core-shell nanoparticles were subjected to heat treatment at 900° C. for 2 hours, thereby preparing carbonized core-shell nanoparticles.

### EXAMPLE 2

An anode active material was prepared in the same manner as in Example 1 except that the polyacrylic acid had a number average molecular weight (Mₙ) of 1760 g/mol, and the polystyrene had a number average molecular weight (Mₙ) of 77410 g/mol.

### EXAMPLE 3

An anode active material was prepared in the same manner as in Example 1 except that the polyacrylic acid had a number average molecular weight (Mₙ) of 4360 g/mol, and the polystyrene had a number average molecular weight (Mₙ) of 29370 g/mol.

### EXAMPLE 4

An anode active material was prepared in the same manner as in Example 1 except that the polyacrylic acid had a number average molecular weight (Mₙ) of 4010 g/mol, and the polystyrene had a number average molecular weight (Mₙ) of 77410 g/mol.

### EXAMPLE 5

An anode active material was prepared in the same manner as in Example 1 except that the polyacrylic acid had a number average molecular weight (Mₙ) of 12000 g/mol, and the polystyrene had a number average molecular weight (Mₙ) of 29370 g/mol.

### EXAMPLE 6

An anode active material was prepared in the same manner as in Example 1 except that the polyacrylic acid had a number average molecular weight (Mₙ) of 12240 g/mol, and the polystyrene had a number average molecular weight (Mₙ) of 77410 g/mol.

### EXAMPLE 7

An anode active material was prepared in the same manner as in Example 1 except that tetrahydrofuran (THF) was used as a solvent instead of N-methyl-2-pyrrolidone (NMP) (a mixed solution including core-shell nanoparticles of Example 7 is denoted by “P4” in FIG. 7).

### EXAMPLE 8

An anode active material was prepared in the same manner as in Example 2 except that tetrahydrofuran (THF) was used as a solvent instead of N-methyl-2-pyrrolidone (NMP) (a mixed solution including core-shell nanoparticles of Example 8 is denoted by “P5” in FIG. 7).

### EXAMPLE 9

An anode active material was prepared in the same manner as in Example 3 except that tetrahydrofuran (THF) was used as a solvent instead of N-methyl-2-pyrrolidone (NMP) (a mixed solution including core-shell nanoparticles of Example 9 is denoted by “P6” in FIG. 7).

### EXAMPLE 10

An anode active material was prepared in the same manner as in Example 4 except that tetrahydrofuran (THF) was used as a solvent instead of N-methyl-2-pyrrolidone (NMP) (a mixed solution including core-shell nanoparticles of Example 10 is denoted by “P7” in FIG. 7).

### EXAMPLE 11

An anode active material was prepared in the same manner as in Example 5 except that tetrahydrofuran (THF) was used as a solvent instead of N-methyl-2-pyrrolidone (NMP) (a mixed solution including core-shell nanoparticles of Example 11 is denoted by “P8” in FIG. 7).

### EXAMPLE 12

An anode active material was prepared in the same manner as in Example 6 except that tetrahydrofuran (THF) was used as a solvent instead of N-methyl-2-pyrrolidone (NMP) (a mixed solution including core-shell nanoparticles of Example 12 is denoted by “P9” in FIG. 7).

### Comparative Example 1

An anode active material was prepared in the same manner as in Example 1 except that a mixed solution including Si nanoparticles was prepared instead of the mixed solution including core-shell nanoparticles.

### Comparative Example 2

An anode active material was prepared in the same manner as in Example 1 except that polystyrene was used instead of the polyacrylic acid-polystyrene block copolymer.

### Comparative Example 3

An anode active material was prepared in the same manner as in Comparative Example 1 except that tetrahydrofuran (THF) was used as a solvent instead of N-methyl-2-pyrrolidone (NMP) (a mixed solution including Si nanoparticles of Comparative Example 3 is denoted by “C” in FIG. 7).

### Comparative Example 4

An anode active material was prepared in the same manner as in Comparative Example 2 except that tetrahydrofuran (THF) was used as a solvent instead of N-methyl-2-pyrrolidone (NMP) (a mixed solution including a Si-polystyrene mixture of Comparative Example 2 is denoted by “STY” in FIG. 7).

### Comparative Example 5

An anode active material was prepared in the same manner as in Example 7 except that ultrasonication of the mixed solution containing the Si particles was omitted.

### Comparative Example 6

An anode active material was prepared in the same manner as in Example 7 except that polyphenol was used instead of the polyacrylic acid-polystyrene block copolymer.

Based on particle size distribution of Si nanoparticles in the mixed solutions including the Si nanoparticles in Comparative Examples 1 and 3, it could be seen that the particle size distribution of the Si-polystyrene mixture in the mixed solutions including the Si-polystyrene mixture in Comparative Examples 2 and 4 was increased due to phase separation, whereas the core-shell nanoparticles in the mixed solutions including the core-shell nanoparticles in Examples 1 to 12 had a particle size distribution from 135 nm to 150 nm and exhibited excellent dispersibility and stability without phase separation.

It could be seen that, when the carbonized core-shell nanoparticles were prepared by heat treatment of the mixed solutions of Examples 1 to 12 in which the core-shell nanoparticles dispersed, the block copolymer shell remained on the surface of the Si cores. However, as in Comparative Example 5, when the simple mixed solution of the Si particles and the block copolymer was subjected to heat treatment instead of the mixed solution in which the core-shell nanoparticles were dispersed, the Si particles and the block copolymer were separated from each other.

As such, it could be confirmed that, since the carbonized core-shell nanoparticles of Examples 1 to 12 had a block having relatively high affinity for Si, the block copolymer shell remained on the surface of the Si core after carbonization, so that the block copolymer shell of the carbonized core-shell nanoparticles still formed a spherical layer around the Si core. However, since the Si-polyphenol carbonized particles of Comparative Example 6 did not have the block having relatively high affinity for Si, the Si particles and the block copolymer were separated from each other after carbonization.

Although the present invention has been described with reference to some embodiments, it should be understood that the foregoing embodiments are provided for illustration only and are not to be in any way construed as limiting the present invention, and that various modifications, changes, alterations, and equivalent embodiments can be made by those skilled in the art without departing from the spirit and scope of the invention. Therefore, the scope of the invention should be limited only by the accompanying claims and equivalents thereof.

What is claimed is:

1. A method of preparing a solution including core-shell nanoparticles, the method comprising:
a) producing a mixed solution by mixing a block copolymer with a solvent, the block copolymer including a block having relatively high affinity for Si and a block having relatively low affinity for Si,;
b) adding Si particles to the mixed solution; and
c) dispersing the Si particles in the mixed solution.

2. The method according to claim 1, wherein the solvent comprises at least one selected from the group consisting of N-methyl-2-pyrrolidone (NMP), tetrahydrofuran (THF), water, methanol, ethanol, cyclohexanol, cyclohexanone, methyl ethyl ketone, acetone, and dimethyl sulfoxide (DMSO).

3. The method according to claim 1, wherein the block having relatively high affinity for Si includes one selected from the group consisting of polyacrylic acid, polyacrylate, polymethacrylic acid, polymethyl methacrylate, polyacryl amide, carboxymethyl cellulose, polyvinyl acetate, and polymaleic acid.

4. The method according to claim 1, wherein the block having relatively low affinity for Si includes one selected from the group consisting of polystyrene, polyacrylonitrile, polyphenol, polyethylene glycol, polylauryl methacrylate, and polyvinyl difluoride.

5. The method according to claim 1, wherein the dispersing comprises one selected from the group consisting of ultrasonication, fine milling, ball milling, three roll milling, stamp milling, eddy milling, homo mixing, planetary centrifugal mixing, homogenization, and vibration shaker treatment.

6. The method according to claim 5, wherein the ultrasonication is performed at 10 kHz to 100 kHz for 1 minute to 120 minutes.
